(19) United States
(12) Patent Application Publication
(10) Pub. No.: US 2005/0120685 A1
(43) Pub. Date: Jun. 9, 2005

(54) Centrifugal separator

(75) Inventors: Helmuth Fischer, Remseck (DE); Jan Bolda, Kornwestheim (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 10/922,156

(22) Filed: Aug. 20, 2004

(30) Foreign Application Priority Data
Aug. 23, 2003 (DE) 103 38 769.2

(51) Int. Cl. B01D 45/00

(52) U.S. Cl. 55/406

(57) ABSTRACT

The invention relates to a centrifugal separator for separating oil and/or solid particles entrained in an air stream, particularly for de-oiling crankcase gases of an internal combustion engine. The centrifugal separator has a mixture inlet for the oil and/or solid particle containing air, an air outlet for the cleaned air and an oil outlet for oil and/or solid particles. It has a stator configured as a housing in which a rotor is disposed, which is operably connected to a drive. A basket is non-rotatably connected to the rotor. The basket has a substantially cylindrical part, which extends in the direction of the mixture inlet and substantially parallel to the stator.

### BACKGROUND OF THE INVENTION

The present invention relates to a centrifugal separator for separating oil and/or solid particles entrained in a gas stream, particularly for de-oiling crankcase gases of an internal combustion engine. The invention further relates to a method for cleaning a gas stream, particularly a crankcase ventilation gas, in which a gas stream containing oil and/or solid particles is directed through a mixture inlet into a centrifugal separator.

Published international patent application no. WO 01/00969 A1 discloses a ventilation device with a centrifugal oil separator, which is equipped with an inlet for an oil/air mixture, an outlet for the cleaned air and an outlet for the oil. The centrifugal oil separator used in this prior-art ventilation device has a rotor, which is arranged in a stationary housing. Along its circumference the rotor has several layers through which the fluid-containing gas flows. Under the influence of the centrifugal force, the droplets are deposited along these layers and discharged through the oil outlet. To prevent the untreated fluid from bypassing the layers of the rotor and flowing directly to the outlet, a contact seal is provided between the rotor and the housing.

The cleaned air exiting from the centrifugal oil separator is typically fed into the intake tract of an internal combustion engine. The cleaned air should therefore contain the least possible amount of oil residues. This makes it possible, on the one hand, to reduce the oil consumption of the internal combustion engine and, on the other hand, to improve the emissions behavior of the internal combustion engine. For modern fuel injection systems, which work with highly sensitive sensors and valves, a particularly high degree of cleanliness of the cleaned air is desirable. This is necessary to avoid damage to the sensitive components and influence on the measured values.

### SUMMARY OF THE INVENTION

It is an object of the present invention to provide an improved centrifugal separator.

Another object of the invention is to provide a centrifugal separator which has a simple construction.

A further object of the invention is to provide a centrifugal separator which exhibits a high separation efficiency.

An additional object of the invention is to provide a centrifugal separator which utilizes an improved sealing concept.

It is also an object of the invention to provide an improved method for cleaning a fluid stream using a centrifugal separator.

These and other objects are achieved in accordance with the present invention by providing a centrifugal separator for separating liquid and/or solid particulate contaminants entrained in a gas stream, comprising a stator configured as a housing, with the housing having a mixture inlet for a gas stream to be cleaned, a gas outlet for cleaned gas, and an outlet for contaminants separated from the gas; a rotor rotatably disposed in the housing; and a drive operably connected to said rotor to rotate the rotor within the housing; in which a basket is non-rotatably connected to the rotor, the basket comprising a substantially cylindrical part which extends in the direction of the mixture inlet and substantially parallel to the stator.

In accordance with a further aspect of the invention, the objects are also achieved by providing a method of cleaning a contaminated gas stream comprising introducing a gas stream contaminated with liquid and/or solid particle contaminants through a mixture inlet into a centrifugal separator, the separator comprising a housing forming a stator and a rotor disposed concentrically inside the housing and operably connected to a drive, the rotor having a basket comprising a cylindrical part attached thereto to rotate therewith; the gas stream flowing into an annular space formed between the rotor and the basket; rotating the rotor and basket whereby the gas stream is caused to rotate and liquid and/or solid particle contaminants from the gas are deposited against the basket under the influence of centrifugal force; and discharging a cleaned gas stream from the centrifugal separator through a cleaned gas outlet and separated liquid and/or solid particle contaminants through a contaminant outlet; in which as a result of pressure differentials created in the gas stream, a partial stream of the cleaned gas stream flows countercurrently through a gap between the outside of the basket and the inside of the housing and is returned to the main flow below the basket.

The centrifugal separator according to the invention for separating oil and/or solid particles entrained in an air stream has a mixture inlet for the air contaminated with oil and/or solid particles, an air outlet for the cleaned air and an oil outlet for the oil and/or solid particles. The housing is designed as the stator for a rotor, which is concentrically arranged inside the housing. The rotor is operably connected to a drive, which accelerates the rotor up to a maximum rotational speed of approximately 25,000 revolutions per minute. In the interior of the housing, a basket is non-rotatably connected to the rotor shaft. This basket comprises a substantially cylindrical part that extends in the direction of the mixture inlet and substantially parallel to the stator.

The gap formed between the outer wall of the basket and the inner wall of the housing can be described by the ratio of the distance between the rotor axis and the outer wall of the basket to the distance between the rotor axis and the inner wall of the housing. This ratio is preferably 0.7 to 0.98. Maintaining this gap width produces an effect that eliminates the need for contact sealing this gap. The resulting flow conditions ensure that the rotation of the basket causes the oil and/or solid particle-laden gas stream likewise to rotate inside the basket, the gas stream to be freed from the entrained oil and/or solid particles under the influence of the centrifugal force, and a portion of this gas stream to flow against the main flow direction between the outer wall of the basket and the inner wall of the housing back toward the inlet opening. This is a result of the different pressure ratios, which are determined by the distance ratio.

As the rotor turns, the air trapped between the rotor axis and the basket is accelerated radially outwardly, which causes the main mass flow to be shifted radially outwardly in the direction of the inner wall of the basket. A pressure profile is furthermore created in radial direction, and the flow against the upper end face of the housing leads to an additional accumulation effect. This pumping results in an axial pressure profile in the gap between the basket and the housing wall, which causes the above-described flow against the main flow between the outer wall of the basket and the inner wall of the housing. Thus, a certain proportion of the total mass flow is continuously directed in a bypass.

If the gap between the outer wall of the basket and the inner wall of the housing is too large, regular eddy structures form, which increase the resistance in the gap. These regular eddy structures—also referred to as Taylor eddies—are created in the gap between the rotating basket wall and the stationary housing wall as a function of the speed and the gap width.

The material of the centrifugal separator according to the invention may be selected freely, but care must be taken that it is sufficiently rigid to prevent the basket or the rotor from changing shape at the extremely high speeds.

According to one advantageous embodiment of the invention, the basket extends over nearly the entire length of the inner housing and thereby separates an inner annular space in the interior of the basket between the inside of the basket and the outside of the rotor shaft from an outer space between the outside of the basket and the inner wall of the housing. The fullest possible coverage of the inner wall of the housing by the basket has a very positive influence on the course of the flow on the one hand and increases the separation efficiency on the other. The inflowing gas contaminated with oil and/or solid particles is subject to a very strong rotation, such that extremely high centrifugal forces act on the entrained oil and/or solid particles, which can thus be more easily separated in the course of the flow and deposited on the inner wall of the basket. A prerequisite is, of course, that the basket has a closed surface over its entire axial extent. The inner basket surface can be smooth, patterned or structured. This must be adapted to the respective application.

It is advantageous to arrange axially extending guide elements in the interior of the basket to improve the separation of the oil and/or solid particle containing air. These guide elements extend parallel to the rotor axis and preferably across the entire cylindrical area of the basket. The inflowing gas mixture strikes the guide elements, which rotate together with the basket, is entrained by the guide elements and immediately starts to rotate strongly. This substantially improves the separation efficiency of the centrifugal separator. The guide elements can be produced as an integral part of the basket or can subsequently be connected to the basket in a detachable or non-detachable manner. This could be accomplished, for example, by inserting, gluing or welding these guide elements or by some other type of connection. The inwardly directed edges of the guide elements are straight and axially parallel. A zigzag or sinusoidal shape is also feasible, however, to produce certain effects in the gas stream.

According to one advantageous refinement, the guide elements extend radially inwardly up to the rotor shaft and fit tightly against the rotor shaft to form a seal. As a result, the interior of the basket is divided into various pie-shaped segments. Preferably, the guide elements are distributed symmetrically within the basket to avoid an imbalance, which could have a very negative effect at such high speeds. The gas mixture flowing into the segments is subject to a further rotative force because of the guide elements, such that the gas mixture continues to move toward the cleaned air outlet in a tornado-like spiral about a virtual axis within the interior of the segments. The superposition of the rotation about the rotor shaft and the fluid stream's own rotation within the segment causes very high centrifugal forces at specific sections of the gas stream through the addition of the two speeds that act on the entrained oil and or solid particles. As a result, the oil and/or solid particles are urged against the inner segment of the basket where they combine into a viscous oil film and flow downwardly as a result of gravity when the rotor stops. When the rotor turns, the flow of the fluid presses the oil film toward the cleaned air outlet, where it is pushed through slots in the upper portion of the basket or passes over the top edge of the basket. Due to inertia and the rotational force that previously acted on it, the oil film is forced against the inner wall of the housing. As a result of gravity and the flow that acts against the main flow direction within the gap between the basket and the inner wall of the housing, the oil film then flows down along the inner wall of the housing and to the oil outlet.

In a further advantageous embodiment of the invention, the cylindrical portion of the basket and the surface line of the housing form a 0° to 10° angle opening toward the air inlet. This has a positive effect on the pressure difference between the upper part of the gap formed between the outer wall of the basket and the inner wall of the housing and the lower part of the gap formed between the basket and the housing. The resulting greater pressure in the upper region of the gap ensures that the gas within the gap can flow only in the direction of the gas inlet. The exact size of the angle should be adapted to the desired pressure ratios and the requirements, which depend on the application.

According to another embodiment of the invention, the cylindrical part of the basket has a radially inwardly protruding projection at its lower end, which faces the mixture inlet. This projection, on the one hand, again affects the pressure difference within the gap between the cleaned air outlet and the mixture inlet and, on the other hand, the turbulence of the gas mixture in the individual basket segments. The length of the radially inwardly protruding projection again depends on the desired separation result. The positive effect is produced by the different diameter ratios between the inlet and the outlet of the basket. Ideally, this ratio ranges from 0.3 to 0.95.

In one advantageous embodiment of the invention, the drive is hydraulic and uses oil, water or fuel. The reaction effect of an exiting fluid, e.g., oil, water or fuel, or a turbine effect caused by the liquid striking the guide blades is used for this purpose. The advantage is that a great many fluids are available in a motor vehicle, and the required pressure can be readily provided using existing or additional pumps.

It is also possible, however, to use a pneumatic drive. For this purpose, exhaust gases can be used, which are present in any event in a motor vehicle during operation, or gases that are under pressure as a result of some type of compression. In the simplest case, intake air compressed by a turbocharger or, for example, by a separate compressor, can be rerouted to build up the required pressure. Here, too, the reaction principle or a turbine effect could be used.

A third possibility is to use electrical energy for the drive, in which case the drive is configured as a fast running motor.

Depending on the different installation and configuration situations it is necessary to provide different alternative drive arrangements. According to one of these alternatives, the drive is disposed within the rotor in the rotor shaft. In this embodiment, an electric motor is preferred, but the above-described variants with a pneumatic or hydraulic drive are also feasible if suitable bypasses are used.

It is likewise feasible to arrange the drive within the housing and to connect it operably to the rotor shaft. This results in a compact centrifugal separator, which is easy to install and remove and requires only a certain number of connections to the internal combustion engine. For this variant all three of the aforementioned drive types are equally feasible.

Finally, the drive can also be disposed outside the housing and again be operably connected to the rotor shaft. The advantage here is that no special seal is required between the interior of the housing and the drive, so that the drive and the centrifugal separator have two separate housings.

In the method according to the invention for cleaning a gas stream, particularly a crankcase gas, a fluid stream containing oil and/or solid particles is directed through a fluid mixture inlet into a centrifugal separator. The centrifugal separator has a housing, which forms the stator, and a rotor disposed concentrically inside the housing, such that the rotor is operably connected to a drive. The drive can be arranged outside the centrifugal separator and be operably connected to a rotor shaft or it can be integrated in the housing of the centrifugal separator or even integrated in the rotor shaft itself in the form of an electric drive. A basket having a cylindrical part is non-rotatably connected to the rotor shaft.

The fluid stream to be cleaned flows through the fluid inlet into the housing and then through the lower basket opening into the basket. Because of its non-rotatable connection to the rotor shaft the basket has a high speed of rotation and thus also starts to rotate rapidly. Any oil and/or solid particles present in the fluid stream migrate outwardly under the influence of the centrifugal force and are deposited against the inner wall of the basket. The cleaned fluid stream leaves the centrifugal separator through an air outlet, and the separated oil and/or solid particles are discharged through an oil outlet.

A portion of the cleaned fluid stream does not leave the centrifugal separator through the air outlet. Due to the pressure differentials in the fluid stream it flows through the gap between the outer wall of the basket and the inner wall of the housing against the main flow direction and is fed back into the main flow below the basket. The pressure differentials, which are a function of the geometry, and the resultant flow direction against the main flow direction in the gap between the basket and the housing ensure that no untreated fluid can bypass the centrifugal separator through the gap.

According to another advantageous embodiment of the method, the basket is equipped with axially extending guide elements, which extend up to the rotor shaft and are distributed symmetrically around the circumference of the basket. These guide elements partition the basket into pie-shaped segments. The fluid stream now flows through the mixture inlet into the respective segments of the basket, which rotates at a high speed. This guidance of the fluid stream within the guide elements causes the corresponding partial fluid streams in each of the segments to develop their own rotating turbulent flow, such that the fluid mixture, as a result of the added rotational speeds of the partial fluid stream and the rotor, has an extremely high speed at certain points. Because of the weight of the oil and/or solid particles, they are separated within the segments along the guide elements or along the inner wall of the basket under the influence of the centrifugal force. The cohesion forces among the fine oil and/or solid particles create a viscous oil film, which can be discharged through the oil outlet.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures in which:

FIG. 1 is a longitudinal section of a centrifugal separator according to the invention, and

FIG. 2 is a cross section of the cylindrical portion of the basket.

### DETAILED DESCRIPTION OF PREFERRED EMBODIMENTS

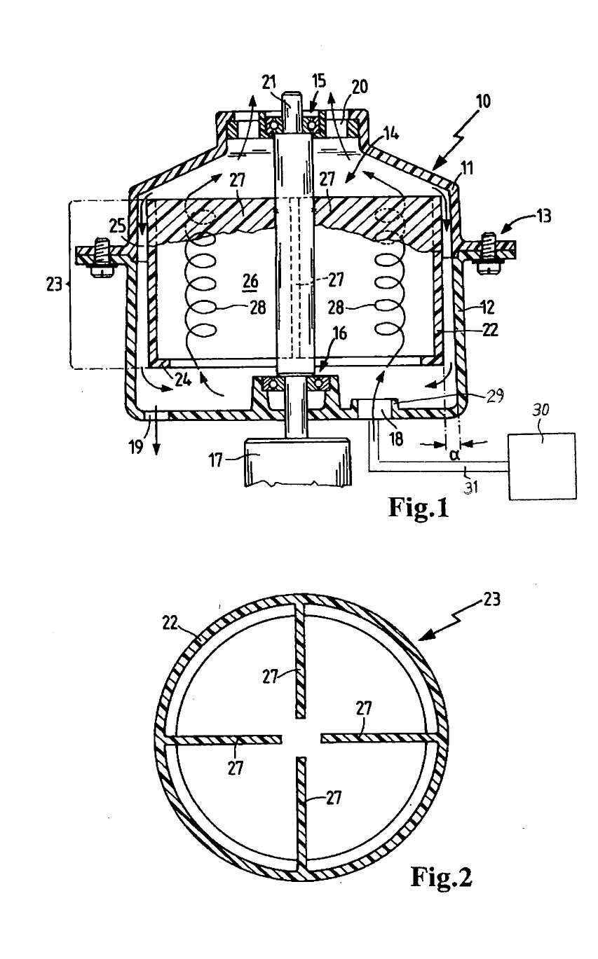

FIG. 1 shows a longitudinal section of a centrifugal separator 10. The centrifugal separator 10 has a housing comprising an upper housing part 11 and a lower housing part 12, which are interconnected via a screwed connection 13. A rotor 14 is rotatably supported inside the housing by a radial bearing 15 in the upper housing part 11 and a radial bearing 16 in the lower housing part 12. The rotor 14 is operably connected to a drive 17, which induces the rotational movement of the rotor 14.

A fluid inlet 18 and an oil outlet 19 are arranged in the lower housing part 12. The fluid inlet 18 has a raised collar 29 to prevent any accumulated oil and/or solid particles from escaping through this fluid inlet 18. In contrast, the oil outlet 19 is disposed at the lowest point of the lower housing part 12. It is furthermore advantageous to arrange the oil outlet 19 radially as far from the center axis of the rotor 14 as possible because the oil and/or solid particles are also urged radially outwardly by the rotation of the rotor. In the embodiment shown here the fluid inlet 18 is axially parallel to the rotor 14. This fluid inlet 18 can also be disposed at an angle or perpendicularly to the rotor 14, particularly radially to the rotor 14 or tangentially to the housing 11, 12.

The rotor 14 comprises a rotor shaft 21 and has a basket 22 that is non-rotatably connected to the rotor shaft 21. The basket 22, which is open in the direction of the air outlet 20 and the fluid inlet 18, comprises a cylindrical part 23, which extends parallel to the rotor shaft 21, and a radially inwardly protruding projection 24 at the lower end of the cylindrical part 23. The outer wall of the basket 22 forms an angle α with the inner wall of the housing 11, 12. This angle α ranges up to approximately 10° and opens in the direction of the fluid inlet 18.

The cylindrical part 23 of the basket 22 separates a gap 25 between the inner wall of the housing 11, 12 and the outer wall of the cylindrical part 23, from a basket volume 26, which is arranged between the rotor shaft 21 and the inner wall of the cylindrical part 23 of the basket 22. In the interior of the basket 22, there are guide elements 27 which extend axially parallel to the rotor shaft 21 and—starting from the cylindrical part 23—extend up to the rotor shaft 21. Thus, the basket volume 26 is divided into a plurality of segments.

The path of the gas stream is indicated by arrows 28 in FIG. 1. The gas stream may, for example, be a stream of crankcase vent gas that flows from the crankcase of an internal combustion engine 30 (illustrated only schematically) through a crankcase vent line 31. It can be seen that the air flows through the fluid inlet 18 into the basket volume 26 of the cylindrical part 23 of the basket 22 and is caused to rotate in a spiral manner within the individual segments which are formed by the guide elements 27 which partition the basket volume 26 (See FIG. 2). Under the influence of the centrifugal force the oil and/or solid particles are deposited along the inner walls of the basket 22 and/or along the guide elements 27.

The cleaned air leaves the basket volume 26, with the major part of the cleaned air flowing out of the centrifugal separator 10 through the air outlet 20. Due to a pressure differential, a partial stream of the cleaned air is forced into the gap 25 and flows against the main flow direction in the gap 25 toward the fluid inlet 18. After leaving the gap 25, this partial stream mixes with the incoming fluid mixture and again passes through the basket volume 26. It is important to select the geometry of the rotor relative to the housing in such a way that a certain partial stream is always flowing against the main flow direction toward the gap 25 to prevent untreated fluid from flowing through the gap in the main flow direction. This is necessary to ensure the high separation efficiency of the centrifugal separator 10.

FIG. 2 shows a cross section of the cylindrical part 23 of the basket 22 without the remaining components of the centrifugal separator 10. Components corresponding to those of FIG. 1 are identified by the same reference numerals. FIG. 2 clearly shows the arrangement of the guide elements 27 across the circumference of the cylindrical part 23 of the basket 22. In this embodiment, the guide elements 27 are integral with the basket 22 and preferably all have the same geometry. The uniform distribution of the guide elements 27 around the circumference of the cylindrical part 23 of the basket 22 ensures that the basket 22 is properly centered. The length of the guide elements 27 also has a positive effect on the centering if the guide elements extend from the basket 22 up to the rotor shaft 21—as shown in this example.

The foregoing description and examples have been set forth merely to illustrate the invention and are not intended to be limiting. Since modifications of the describe embodiments incorporating the spirit and substance of the invention may occur to persons skilled in the art, the invention should be construed broadly to include all variations within the scope of the appended claims and equivalents thereof.

1. A centrifugal separator for separating liquid and/or solid particulate contaminants entrained in a gas stream, said separator comprising a stator configured as a housing, said housing having a mixture inlet for a gas stream to be cleaned, a gas outlet for cleaned gas, and an outlet for contaminants separated from the gas; a rotor rotatably disposed in said housing; and a drive operably connected to said rotor to rotate the rotor within the housing; wherein a basket is non-rotatably connected to the rotor, said basket comprising a substantially cylindrical part which extends in the direction of the mixture inlet and substantially parallel to the stator.

2. A centrifugal separator according to claim 1, wherein said mixture inlet is connected in fluid communication with a crankcase vent of an internal combustion engine, and said gas stream is a stream of crankcase gases contaminated with oil and/or solid particles from a crankcase of the internal combustion engine.

3. A centrifugal separator according to claim 1, wherein the basket extends over nearly the entire interior length of the housing and separates an inner annular space within the interior of the basket from an outer gap space between the basket and an inner wall of the housing.

4. A centrifugal separator according to claim 1, wherein guide elements extending in axial direction are disposed in the interior of the basket.

5. A centrifugal separator according to claim 4, wherein the guide elements extend radially inwardly up to the rotor shaft and contact the shaft.

6. A centrifugal separator according to claim 1, wherein the cylindrical part of the basket and the inside of the housing form an angle of 0° to 10° which opens toward the mixture inlet.

7. A centrifugal separator according to claim 1, wherein the cylindrical part of the basket has a radially inwardly protruding projection at its lower end, which influences the flow.

8. A centrifugal separator according to claim 1, wherein the drive is hydraulic and is driven by oil, water or fuel.

9. A centrifugal separator according to claim 1, wherein the drive is pneumatic and is driven by exhaust gas or a pressurized gas.

10. A centrifugal separator according to claim 1, wherein the drive is an electric drive.

11. A centrifugal separator according to claim 1, wherein the drive is disposed within the rotor.

12. A centrifugal separator according to claim 1, wherein the drive is disposed within the housing.

13. A centrifugal separator according to claim 1, wherein the drive is disposed outside the housing.

14. A method for cleaning a contaminated gas stream, said method comprising:
introducing a main flow gas stream contaminated with liquid and/or solid particle contaminants through a mixture inlet into a centrifugal separator, said separator comprising a housing forming a stator and a rotor disposed concentrically inside the housing and operably connected to a drive, said rotor having a basket comprising a cylindrical part attached thereto to rotate therewith; said gas stream flowing into an annular space formed between said rotor and said basket;
rotating the rotor and basket whereby the gas stream is caused to rotate and liquid and/or solid particle contaminants from the gas are deposited against the basket under the influence of centrifugal force; and
discharging a cleaned gas stream from the centrifugal separator through a cleaned gas outlet and separated liquid and/or solid particle contaminants through a contaminant outlet;
wherein as a result of pressure differentials created in the gas stream, a partial stream of the cleaned gas stream flows countercurrently through a gap between the outside of the basket and the inside of the housing and is returned to the main flow below the basket.

15. A method according to claim 14, wherein said fluid stream is crankcase ventilation gas contaminated with oil and/or solid particles.

16. A method for cleaning a gas stream according to claim 14, wherein the gas stream is caused to rotate by axially-extending guide elements mounted in the basket such that the gas stream has its own turbulent flow within internal segments of the basket defined by the guide elements, and oil and/or solid particles suspended in the gas are deposited against the basket and the guide elements under the influence of centrifugal force.
